(19) United States
(12) Patent Application Publication
(10) Pub. No.: US 2016/0147795 A1
(43) Pub. Date: May 26, 2016

(54) METHODS OF RECOGNIZING AN OBJECT WITHIN AN IMAGE BY USE OF TEMPLATES

(71) Applicant: Imaginestics, LLC, West Lafayette, IN (US)

(72) Inventor: Jamie Tan, West Lafayette, IN (US)

(73) Assignee: IMAGINESTICS, LLC, West Lafayette, IN (US)

(21) Appl. No.: 14/709,724

(22) Filed: May 12, 2015

Related U.S. Application Data
(60) Provisional application No. 62/082,669, filed on Nov. 21, 2014.

(51) Int. Cl. G06F 17/30

(52) U.S. Cl. CPC G06F 17/30277; G06F 17/30247

(57) ABSTRACT

A method of providing an input to an image-based search engine, including enabling a user to view an image of an object on a display screen of an electronic device. A plurality of templates are provided to the user. A selection of one of the templates is received from the user. The selected template is presented on the display screen in association with the image of the object on a display screen. The user is enabled to adjust a viewpoint of the image of the object on the display screen to match a viewpoint of the selected template. An image of the object is captured from the adjusted viewpoint. The captured image is transmitted to, and received by, the image-based search engine. The search engine is used to identify in a database image data best representing the captured image.

### CROSS REFERENCE TO RELATED APPLICATION

This application claims the benefit of U.S. Provisional Application No. 62/082,669, filed Nov. 21, 2014, the entirety of which is hereby incorporated herein by reference.

### FIELD

Embodiments of the present disclosure generally relate to searching for images in an electronic database.

### SUMMARY

The invention comprises, in one embodiment, a method of providing an input to an image-based search engine, including enabling a user to view an image of an object on a display screen of an electronic device. A plurality of templates are provided to the user. A selection of one of the templates is received from the user. The selected template is presented on the display screen in association with the image of the object on the display screen. The user is enabled to adjust a viewpoint of the image of the object on the display screen to match a viewpoint of the selected template. An image of the object is captured from the adjusted viewpoint. The captured image is transmitted to, and received by, the image-based search engine. The search engine is used to identify in a database image data best representing the captured image.

The invention comprises, in another embodiment, a method of defining an input to an image-based search engine, including enabling a user to view an image of an object on a display screen of an electronic device. A plurality of templates are provided to the user. A selection of one of the templates is received from the user. The selected template is presented on the display screen such that the selected template is superimposed on the image of the object on a display screen. First image data is transmitted to, and received at, an image-based search engine. The first image data represents the selected template superimposed on the image of the object on the display screen. The search engine is used for identifying in a database second image data best representing the object. The identifying is dependent upon indications of the selected template in the first image data.

The invention comprises, in yet another embodiment, a method of providing an input to an image-based search engine, including enabling a selected template to be presented on a display screen of an electronic device in association with an image of an object. At the search engine, an image is received of the object captured from an adjusted viewpoint resulting from the user adjusting a viewpoint of the image of the object on the display screen to match a viewpoint of the selected template. The search engine is used to identify in a database image data best representing the image captured from the adjusted viewpoint.

An advantage of the invention is that it may enable a user to take a picture of an object from a viewing angle that best matches the viewing angle of images of similar objects in a database. Thus, when the captured object image is entered into an image-based search engine, the engine may better recognize the object as matching a similar object in the database.

Another advantage of the invention is that it may enable an image-based search engine to better recognize an object in an input image and thereby better define image data that is used as an input to an image search.

### BRIEF DESCRIPTION OF THE DRAWINGS

FIG. 1 is a schematic view of a mobile electronic device having on its screen an object to be recognized according to one embodiment of the present invention.

FIG. 2 is a block diagram of one embodiment of an image-based search engine arrangement of the present invention.

FIG. 3 is a schematic view of a mobile electronic device having on its screen a toolbar including templates of the present invention and an image of an object to be searched for by an image-based search engine being presented on the display screen of the device.

FIG. 4 is a schematic view of the mobile electronic device of FIG. 3 having on its screen a selected template of the invention superimposed on the image of the object to be seared for.

FIG. 5 is a schematic view of the mobile electronic device of FIG. 4 with the object image having been enlarged, and a viewpoint from which the object image is viewed having been changed by the user by moving the camera to a higher elevation and pointing the camera more downwardly in order to match the viewpoint of the selected template.

FIG. 6 is a schematic view of a mobile electronic device according to another embodiment of the invention having on its screen a template of the present invention that may be used to model an image of an object.

FIG. 7 is a schematic view of a mobile electronic device having on its screen an image of an object to be recognized.

FIG. 8 is a schematic view of the mobile electronic device of FIG. 7 having on its screen a template of the invention superimposed on the image of the object to be recognized.

FIG. 9 is a schematic view of the mobile electronic device of FIG. 8 with the template having been enlarged.

FIG. 10 is a schematic view of the mobile electronic device of FIG. 9 with the template having been further enlarged.

### DETAILED DESCRIPTION

In one embodiment, the invention may be applied to a search engine that may search for images of two or more dimensions.

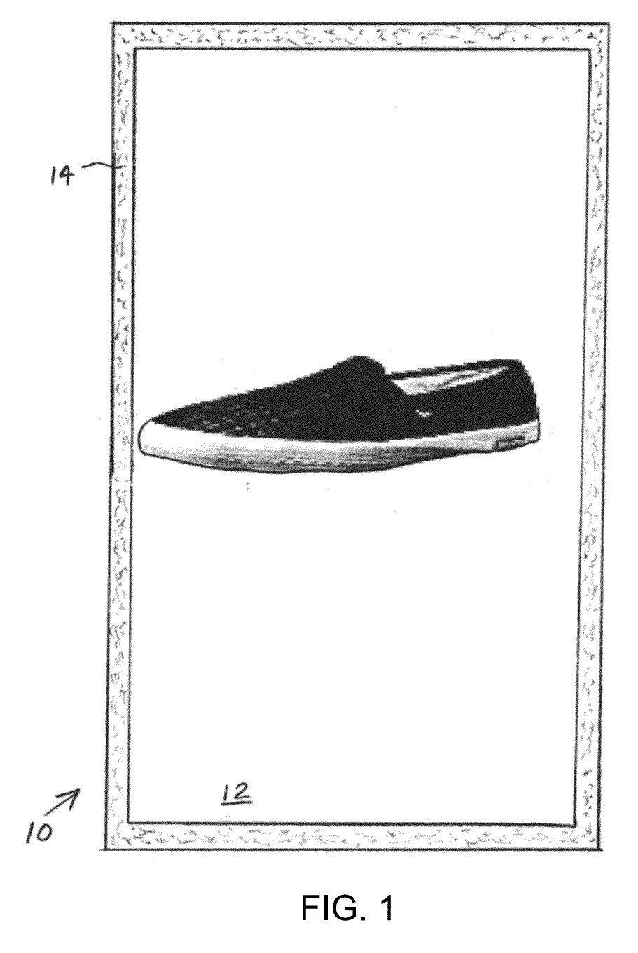

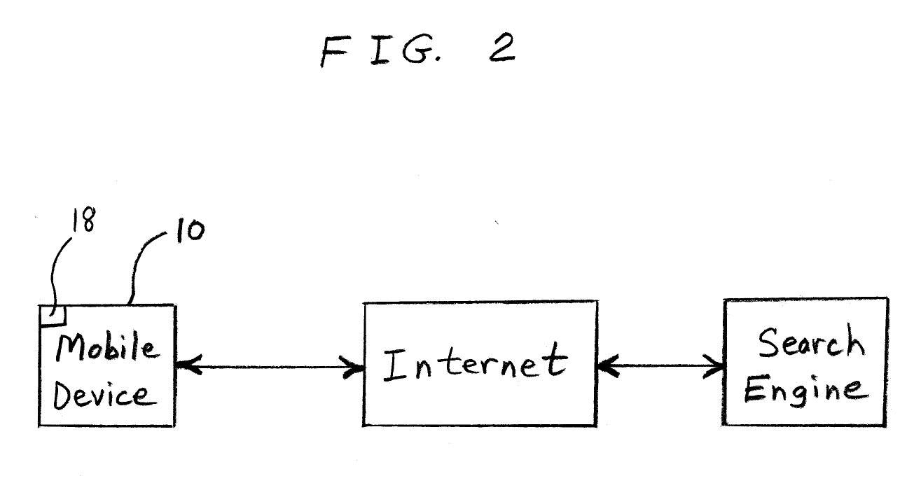

In FIG. 1 there is shown a mobile electronic device 10 (e.g., an iPhone) having a touch-sensitive display screen 12 surrounded on all four sides by a plastic frame 14 serving as a border of screen 12. An image, or part of an image, on screen 12 may be used as an input to an image-based search engine that searches a database for other images in the database that match or are similar to the image on screen 12 at least in some respect. Device 10 may be connected to the search engine through a hard wire connection or wirelessly, and may be connected to the search engine directly or indirectly such as via the Internet, as shown in FIG. 2.

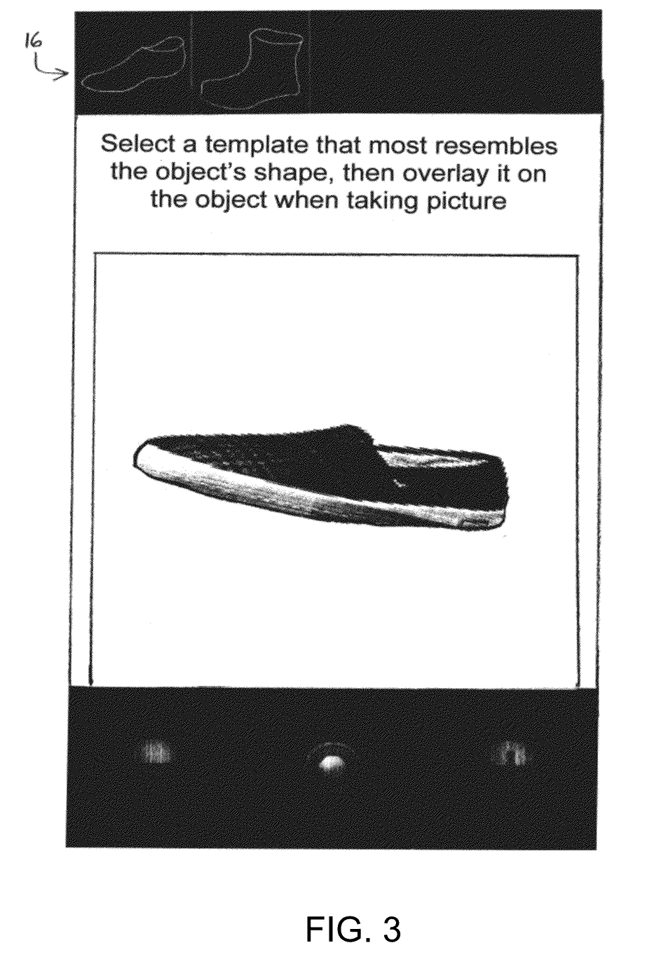

FIG. 3 illustrates a tool bar 16 including a plurality of candidate templates which may be selectable by the user. Only two such templates are shown in FIG. 3 for ease of illustration. However, it is to be understood that the toolbar, or possibly a plurality of rows of toolbars, may include as many templates as can practicably be seen and selected by the user.

The templates may be organized into categories and sub-categories, and only templates in the category/sub-category selected by the user may be included in toolbar 16. For example, a category may be “footwear”, and a sub-category may be “slippers”. The categories and sub-categories may be selected by the user, for example, via an on-screen menu, via voice recognition, or via entering text into device 10.

As shown in FIG. 3, the user has framed an object in the form of a shoe in a viewfinder of camera 18 of device 10 and hence the object is being displayed on screen 12. The object, in this case a shoe, is an object that the user would like to search for, or find a similar object, in a database. An image-based search engine may be used to search the database for images of a similar or identical object. The display screen is also shown to present text instructions to the user, such as “Select a template that most resembles the object's shape, then overlay it on the object when taking picture.” Knowing that the object is a shoe, the user may select the shoe or footwear category or sub-category for inclusion in toolbar 16. The user may then look at all the templates presented in toolbar 16 and select the template that most resembles the shoe whose image is displayed on screen 12. In one embodiment, the user selects the template that best matches the shape, profile or outer surface of the shoe whose image is displayed on screen 12.

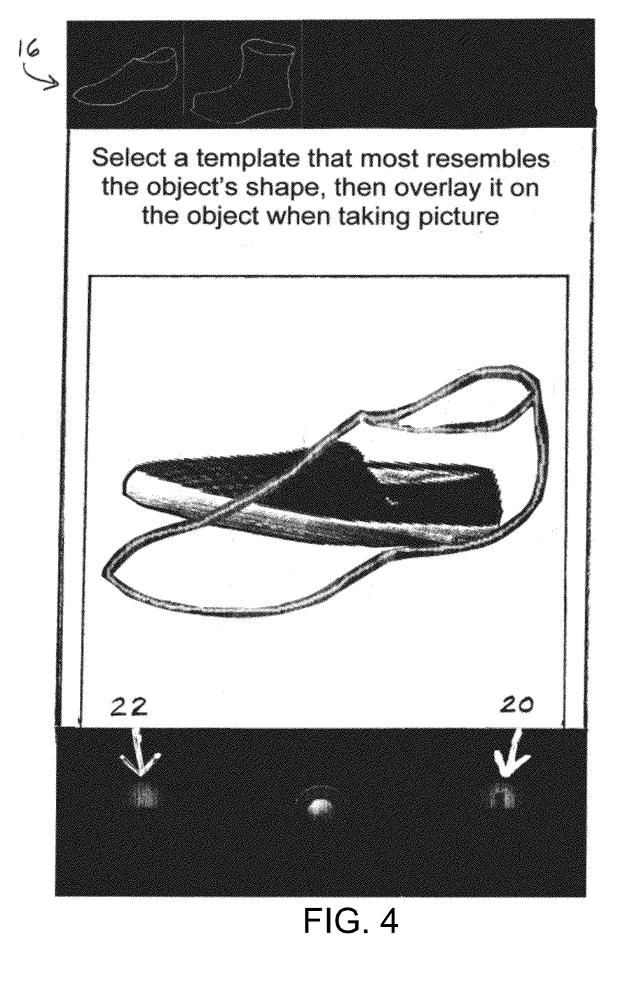

FIG. 4 illustrates the device of FIG. 3 after the user has touched and selected the leftmost template on toolbar 16, and consequently the selected template is displayed on the screen (i.e., in addition to the display on toolbar 16). After its selection, the template is superimposed or overlaid on the image of the shoe on screen 12. As shown, the shoe image is obviously smaller than the template in terms of the sizes of their on-screen images within the viewfinder. In order to make their sizes better match, the user may press the “+” touch button 20 at the bottom of screen 12 in order to zoom camera 18 and thereby increase the size of the object image on screen 12. Conversely, if the image of the object were larger than the image of the template on screen 12, then the user may press the “−” touch button 22 at the bottom of screen 12 in order to decrease the size of the object image. Alternatively, the user may simply move camera 18 closer to the shoe or farther away from the shoe in order to change the size of the shoe image in the viewfinder.

Also as shown in FIG. 4, the image of the shoe is from a more horizontal viewpoint than is the template. That is, the viewing angle of the image of the shoe is closer to parallel with the sole of the shoe than is the viewing angle of the template. The viewpoint or viewing angle of the template may generally represent the viewpoint of the images in the database, and may particularly represent the viewpoint of the images in the database whose shapes are similar to the shape of the template. That is, the shoe images in the database may generally be from the viewpoint of the selected leftmost template in toolbar 16. In order to capture an image of the shoe that more closely matches the viewpoint of the selected template, and thus enable the search engine to more accurately find an image in the database that matches the shoe, the user may elevate the camera and point it in a more downward direction toward the shoe. The user may also rotate the camera about a vertical axis intersecting the shoe if doing so will make the camera angle more closely match the template viewpoint, in the user's judgment.

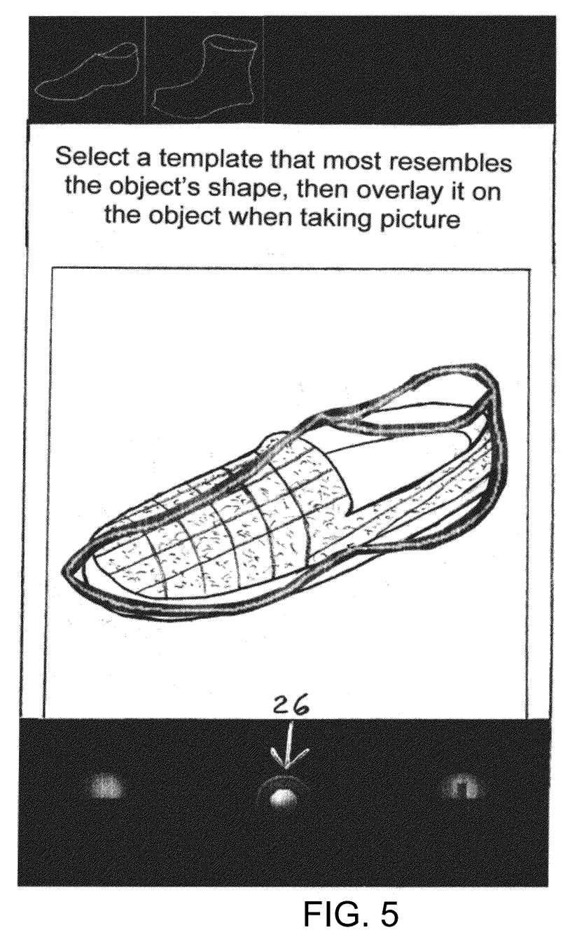

FIG. 5 illustrates device 10 of FIG. 4 after the user has pressed “+” touch button 20 enough times that the size of the object image approximately matches the size of the selected template, and after the user has manually moved and pointed camera 18 such that the shoe image is from a viewpoint approximately equivalent to the viewpoint of the selected template. The user may need to move device 10 and camera 18, and hence the viewfinder of camera 18, until the image of the shoe is centered on the template. After the user is satisfied with the centering of the object image on the template, he may press touchbutton 26 (FIG. 5) in order to cause camera 18 to capture an image of the object (e.g., shoe). An image including the captured object image may be transmitted to the search engine. The search engine may use the object image to find an image in the database that most closely matches the object image.

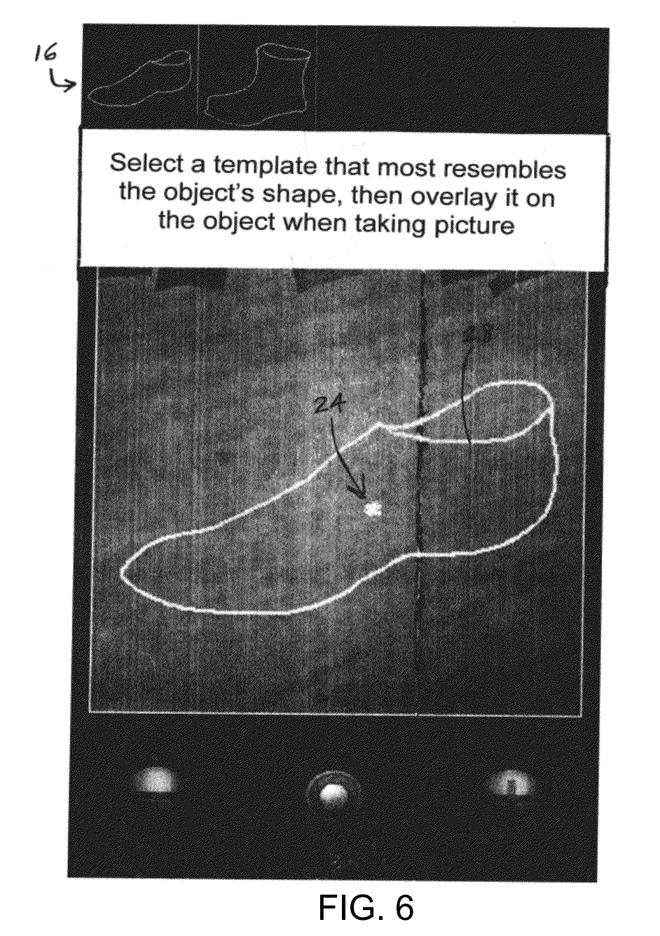

In another embodiment illustrated in FIGS. 6-10, a template is used not just to properly size the object image and guide the user in capturing the object image from an advantageous viewpoint, but rather the template itself may be used by the search engine to improve the recognition of the object in the captured image. This embodiment may be particularly useful in the event that a relatively large number of templates are stored in the database such that a template that fairly closely matches the searched for object can likely be found in the database. FIG. 6 illustrates a tool bar 16 including a plurality of candidate templates which may be selectable by the user. Only two such templates are shown in FIG. 6 for ease of illustration. However, it is to be understood that the toolbar, or possibly a plurality of rows of toolbars, may include as many templates as can practicably be seen and selected by the user.

The templates may be organized into categories and sub-categories, and only templates in the category/sub-category selected by the user may be included in toolbar 16. For example, a category may be “footwear”, and a sub-category may be “slippers”. The categories and sub-categories may be selected by the user, for example, via an on-screen menu, via voice recognition, or via entering text into device 10.

As shown in FIG. 6, the user has touched and selected the leftmost template on toolbar 16, perhaps before framing an object in a viewfinder of camera 18 of device 10, and consequently the selected template is displayed on the screen (i.e., in addition to the display on toolbar 16). The display screen is also shown to present text instructions to the user, such as “Select a template that most resembles the object's shape, then overlay it on the object when taking picture.”

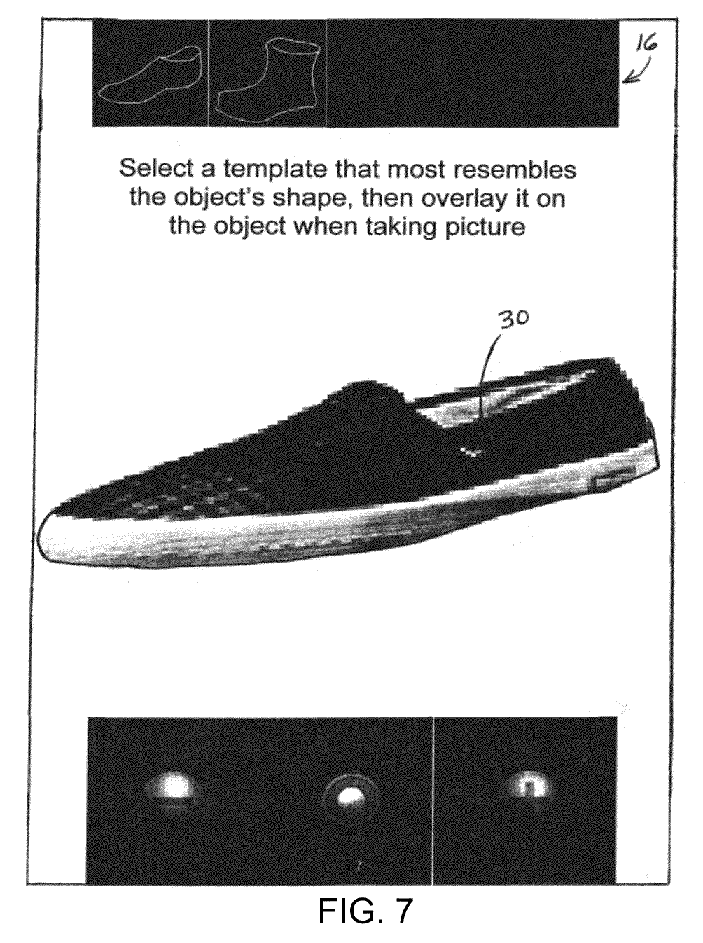

FIG. 7 illustrates device 10 with an object in the form of a shoe being framed in the viewfinder of camera 18 and hence being displayed on screen 12. The user may want to find an image or images of a similar or identical shoe in a database via a search engine. Knowing that the object is a shoe, the user may select the shoe or footwear category or sub-category for inclusion in toolbar 16. The user may then look at all the templates presented in toolbar 16 and select the template that most resembles the shoe whose image is displayed on screen 12. In one embodiment, the user selects the template that best matches the shape, profile or outer surface of the shoe whose image is displayed on screen 12.

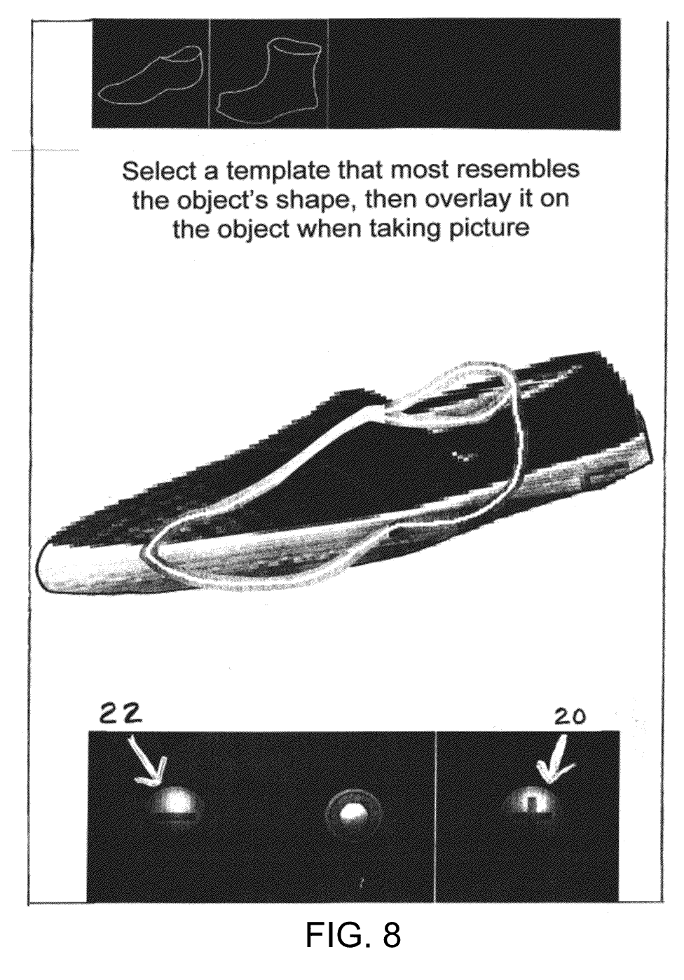

FIG. 8 illustrates device 10 of FIG. 7 after the user has selected the leftmost template on toolbar 16. After its selection, the template is superimposed or overlaid on the image of the shoe on screen 12. As shown, the template is obviously smaller than the shoe in terms of the sizes of their on-screen images. In order to make their sizes better match, the user may press the “+” touch button 20 at the bottom of screen 12 in order to increase the size of the template. Conversely, if the image of the template were larger than the image of the shoe on screen 12, then the user may press the “−” touch button 22 at the bottom of screen 12 in order to decrease the size of the template.

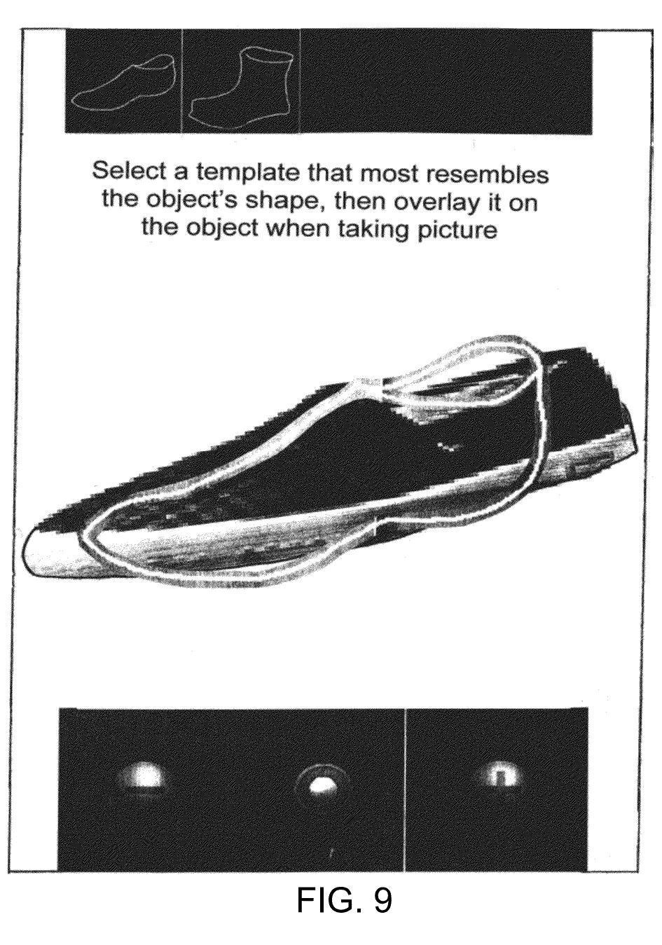

FIG. 9 illustrates device 10 of FIG. 8 after the user has pressed “+” touch button 20 one or more times. As shown, the template has increased in size, but it is still smaller than the image of the shoe.

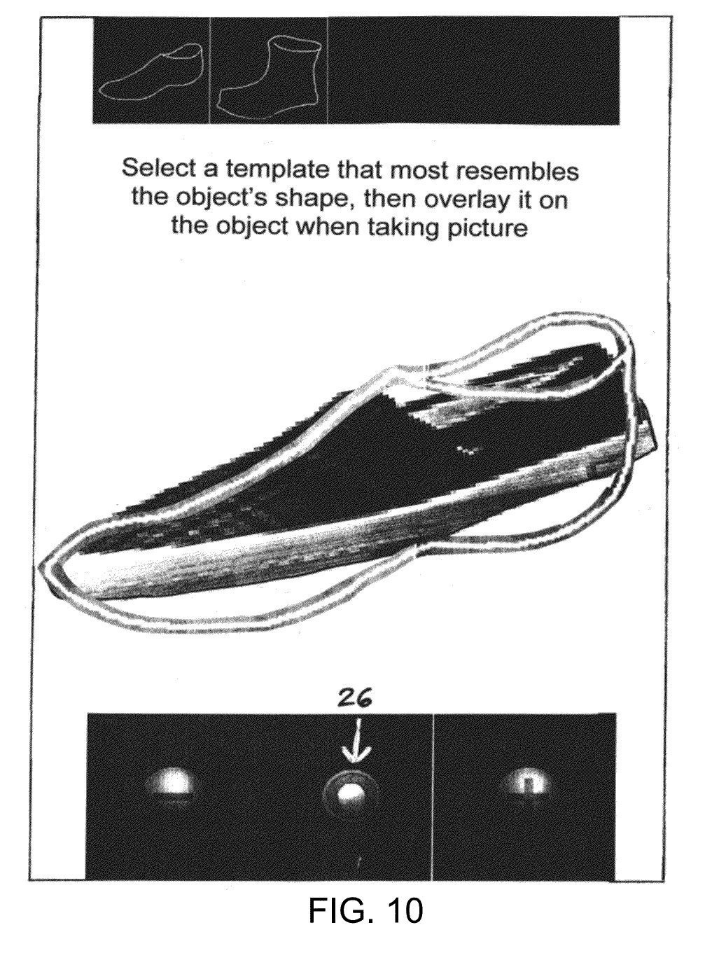

FIG. 10 illustrates device 10 of FIG. 9 after the user has pressed “+” touch button 20 enough times that the size of the template approximately matches the size of the shoe image on-screen. The user may need to move device 10 and camera 18, and hence the viewfinder of camera 18, until the image of the shoe is centered on the template, or until the centroids of the template and the shoe image are at the same location on screen 12. To aid in this centering process, a dot 24 (FIG. 6) representing the centroid of the template may be presented with the template, even while the template is overlaid on the object image (although the centroid dot is not shown in FIGS. 8-10 for clarity of illustration), so that the user can overlay dot 24 on what he perceives as the centroid of the object image. After the user is satisfied with the centering of the object image on the template, he may press touchbutton 26 (FIG. 10) in order to cause camera 18 to capture an image of the object (e.g., shoe). An image including both the captured object image and the template centered on the captured object image with matching size may be transmitted to the search engine.

The search engine may use the overlaid template to recognize the object in the captured image. For example, the search engine may use the periphery or outer boundary of the template to identify the location of the periphery or outer boundary of the captured object image. That is, the search engine may use the template as a guide in determining where in the captured image the object ends and the background begins, or where other objects in the background begin. The captured object image may have several candidate lines or boundaries having one color on one side of the line or boundary, and another color on the other side of the line or boundary. Hence, the search engine may use the template to determine which of the candidate lines or boundaries is the true boundary of the object in the image. For example, the search engine may use a least squares method to determine which of the candidate lines or boundaries is closest to the line or boundary in the template, and the search engine may then assume that this closest line or boundary in the object image is the true line or boundary of the object.

In addition to determining the boundaries of the two-dimensional profile of the object, the template may also help the search engine recognize recesses or projections within the boundaries of the two-dimensional profile of the object. For example, an interior arcuate line 28 (FIG. 6) in the selected shoe template may be used by the search engine to recognize the location of the top line 30 (FIG. 7) of the shoe in the captured shoe image.

As described above, the search engine may use the template to recognize and/or determine the three-dimensional locations of the profiles, edges, shapes, outer surfaces, recesses, and/or projections of the object in the captured image. The search engine may then use this shape information to identify two-dimensional images and/or three-dimensional images in the database that best match the object whose image was captured by camera 18.

The invention has been described herein as including “+” and “−” pushbuttons or touchbuttons 20, 22 for increasing or decreasing, respectively, the size of the template as presented on screen 12. Alternatively, “+” and “−” pushbuttons or touchbuttons 20, 22 may be used for increasing or decreasing, respectively, the size of the image of the object (e.g., the shoe) as presented on screen 12. As another alternative, a pushbutton or touchbutton similar or identical to touchbutton 26 may be used to toggle between touchbuttons 20, 22 controlling the size of the template and controlling the size of the image as presented on screen 12.

The invention has been described herein as utilizing an inventory of “off-the-shelf” or non-customizable templates to model the object whose image is to be captured. However, in another embodiment, the templates may be customizable initial starting points that the user may edit on-screen to better match the object image. For example, after selecting a template and resizing the template to approximately match the object image, the user may press a touchbutton to enter an erase mode in which the user may erase inappropriate or undesired portions of the template by wiping them away by virtue of dragging his finger across screen 12. The user may also press a touchbutton to enter a draw mode in which the user may add lines to the template by drawing the lines with his finger, his finger here too being dragged across screen 12.

The templates may be stored on device 10 for retrieval by the user. Alternatively, the templates may be stored in the search engine or in the database from where they may be retrieved by the user. In one embodiment, a library of templates is stored in the database and is dynamically modified to best fit, best categorize, or to equally represent the two-dimensional and/or three-dimensional images that are currently being stored in the database. That is, as images are added to or deleted from the database, the library of templates may be dynamically modified (e.g., templates added to or deleted from the library), perhaps by the search engine, to most efficiently (e.g., with a minimum number of templates) model the images that are presently stored in the database.

In the embodiments of the invention described above, the template may be selected by the user. However, in other embodiments, the search engine selects the template based on an image of the object as initially viewed and/or captured by the user. The initially viewed and/or captured image of the object is transmitted to, and received by, the search engine, which then may select a template that the search engine determines best matches the initially viewed and/or captured image of the object. The template selected by the search engine may then be presented on-screen to the user, and the user may, in response, adjust the camera's viewpoint or viewing angle of the object to better match, in the user's estimation, the viewpoint or viewing angle of the template. An image of the object captured by the camera from the thusly adjusted viewpoint/viewing angle may then the transmitted to, and received by, the search engine for searching the database for a matching object image in the database.

While this invention has been described as having an exemplary design, the present invention may be further modified within the spirit and scope of this disclosure. This application is therefore intended to cover any variations, uses, or adaptations of the invention using its general principles.

What is claimed is:

1. A method of providing an input to an image-based search engine, comprising the steps of:
enabling a user to view an image of an object on a display screen of an electronic device;
providing a plurality of templates to the user;
receiving from the user a selection of one of the templates;
presenting the selected template on the display screen in association with the image of the object;
enabling the user to adjust a viewpoint of the image of the object on the display screen to match a viewpoint of the selected template;
receiving at the search engine an image of the object captured from the adjusted viewpoint; and
using the search engine to identify in a database image data best representing the image of the object captured from the adjusted viewpoint.

2. The method of claim 1, wherein the templates are two-dimensional.

3. The method of claim 1, comprising the further step of presenting only a subset of available said templates on the display screen, the displayed templates being in a same category identified by the user.

4. The method of claim 1, further comprising the step of enabling the user to increase and decrease a size scale of the image of the object as presented on the display screen.

5. The method of claim 1, further comprising the step of enabling the user to adjust a viewpoint of the image of the object as presented on the display screen to match a viewpoint of the selected template.

6. The method of claim 1, wherein the image data is two-dimensional.

7. The method of claim 1, wherein the image data is three-dimensional.

8. The method of claim 1, wherein the image is captured by a camera of the electronic device.

9. The method of claim 1, wherein the selected template is presented on the display screen such that the selected template is superimposed on the image of the object on the display screen.

10. A method of defining an input to an image-based search engine, comprising the steps of:
enabling a user to view an image of an object on a display screen of an electronic device;
providing a plurality of templates to the user;
receiving from the user a selection of one of the templates;
presenting the selected template on the display screen such that the selected template is superimposed on the image of the object on a display screen;
receiving first image data at the image-based search engine, the first image data representing the selected template superimposed on the image of the object on the display screen; and
using the search engine for identifying in a database second image data best representing the object, the identifying being dependent upon indications of the selected template in the first image data.

11. The method of claim 10, wherein the templates are two-dimensional.

12. The method of claim 10, comprising the further step of presenting only a subset of available said templates on the display screen, the displayed templates being in a same category identified by the user.

13. The method of claim 10, further comprising the step of enabling the user to increase and decrease a size scale of the selected template as presented on the display screen.

14. The method of claim 10, wherein the second image data is three-dimensional.

15. The method of claim 10, further comprising the step of enabling the user to electronically modify the template before selecting the template.

16. The method of claim 15, wherein the electronically modifying of the template includes enabling the user to erase a portion of the template and/or add to the template.

17. A method of providing an input to an image-based search engine, comprising the steps of:
enabling a selected template to be presented on a display screen of an electronic device in association with an image of an object;
receiving at the search engine an image of the object captured from an adjusted viewpoint resulting from the user adjusting a viewpoint of the image of the object on the display screen to match a viewpoint of the selected template; and
using the search engine to identify in a database image data best representing the image captured from the adjusted viewpoint.

18. The method of claim 17, wherein the selected template is selected by the user.

19. The method of claim 17, comprising the further steps of:
receiving at the search engine an image of the object; and
using the search engine to select the template based on the received image of the object.

20. The method of claim 17, wherein the selected template is presented on the display screen such that the selected template is superimposed on the associated image of the object on the display screen.
